(19) United States
(12) Patent Application Publication
(10) Pub. No.: US 2015/0142850 A1
(43) Pub. Date: May 21, 2015

(54) CONTEXTUAL COMMUNITY PARADIGM

(71) Applicant: Universal Natural Interface LLC, Issaquah, WA (US)

(72) Inventors: Shigeaki Hakusui, Irvington, NY (US); Yuki Matsuda, Taito-ku (JP); David Leigh Keller, Issaquah, WA (US); Adam Thomas Argyle, Seattle, WA (US)

(73) Assignee: UNIVERSAL NATURAL INTERFACE LLC, Issaquah, WA (US)

(21) Appl. No.: 14/529,018

(22) Filed: Oct. 30, 2014

Related U.S. Application Data
(60) Provisional application No. 61/897,676, filed on Oct. 30, 2013.

(51) Int. Cl. G06F 17/30

(52) U.S. Cl. CPC G06F 17/30867
USPC 707/777

(57) ABSTRACT

A contextual community paradigm is engineered to define context between human and machine. This contextual community paradigm enables support of multiple taxonomies for any given object. Human and machine share context. The contextual community paradigm simplifies resolution of the user's intent, enabling automated interactions between human and machine spanning functions and applications. The paradigm facilitates real-time context resolution. The paradigm also resolves intent for the purpose of automating and assisting in the execution of tasks involving people, devices, and concepts, such as events and information.

### CROSS-REFERENCE TO RELATED APPLICATION

This application claims the benefit of U.S. Provisional Application No. 61/897676, filed Oct. 30, 2013, which is incorporated herein by reference.

### TECHNICAL FIELD

The present subject matter is generally related to software engineering, and more particularly, it relates to programming paradigms.

### BACKGROUND

A programming paradigm is an engineering stylistic methodology of communicatively instructing computing machinery, a way of building the structure and elements of computer programs. Capabilities and styles of various programming languages are defined by their supported programming paradigms. Programming paradigms that are often distinguished include imperative, declarative, functional, object-oriented, logic, and symbolic programming. Regarding an object-oriented paradigm, software engineers liken such a program as a collection of interacting objects, whereas functional programming likens a program to be a sequence of stateless function evaluations. Many programming paradigms are as well known for what techniques they forbid as for what they enable. The object-oriented paradigm is often regarded as doctrinaire or overly rigid by those accustomed to earlier styles.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present subject matter includes a system form which recites a system comprising a machine containing one or more processors, the specific hardware structure of which is suitable for executing pieces of software including: an operating system; a graphical user interface and a media interface; a layer of sockets and HTML5; and a contextual community paradigm interface which is capable of supporting multiple taxonomies for an object, the object being a member of a contextual community, and the object with which a user interacts through the contextual community as if it were a social network.

Another aspect of the present subject matter includes a method form reciting a method comprising: identifying a community and analyzing data to resolve a context; synthesizing taxonomy in real time based on the context; and extracting an intention of a user.

A further aspect of the present subject matter includes a computer-readable medium form which recites a computer-readable medium, which is not transitory, having computer-executable instructions stored thereon for implementing a method, comprising: identifying a community and analyzing data to resolve a context; synthesizing taxonomy in real time based on the context; and extracting an intention of a user.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a pictorial diagram illustrating a logical view of object structures;

FIG. 1B is a pictorial diagram illustrating a physical view of a module architecture;

FIG. 2 is a pictorial diagram illustrating a logical view of object structures;

FIG. 3 is a block diagram illustrating a physical view of archetypical software architecture and archetypical hardware architecture;

FIG. 4 is a block diagram illustrating a logical view of archetypical software architecture; and

FIGS. 5A-5I are process diagrams implementing an archetypical method.

### DETAILED DESCRIPTION

An object-oriented programming paradigm treats any application and its data as an inseparable entity. Data is associated with the application, and a specific function as the method. The method inherits its characteristics from the class that it belongs to. The chief characteristic is a unique taxonomy (unique single line of inheritance). By this means the system can identify a unique function and the file that a user specifies. Under this object-oriented paradigm, a user's intent is resolved by extraction and identification of the context of interaction under a strict hierarchy (whereas various embodiments of the present subject matter are engineered to discover the user's intent without a strict hierarchy). This object-oriented paradigm constrains execution at each step of an application, without unification among applications. There have been various attempts to unify this look and feel, as well as naming conventions, by enforcing style as a framework. This strict enforcement of style constrains freedom of applications, impeding creativity and navigation through complex file systems. Users are forced to follow formalized steps to perform tasks using computers. In other words, conventional paradigms cause complexity by causing taxonomy to vary by individual; computing is burdened because artificial intelligence requires keyword extraction to resolve context yet does not resolve to the actual context of the user; the user is forced to manually execute parts of object-oriented tasks being split among applications; and a single line of inheritance constrains context sharing in object-oriented applications. Various embodiments are engineered to reduce or overcome these technical difficulties.

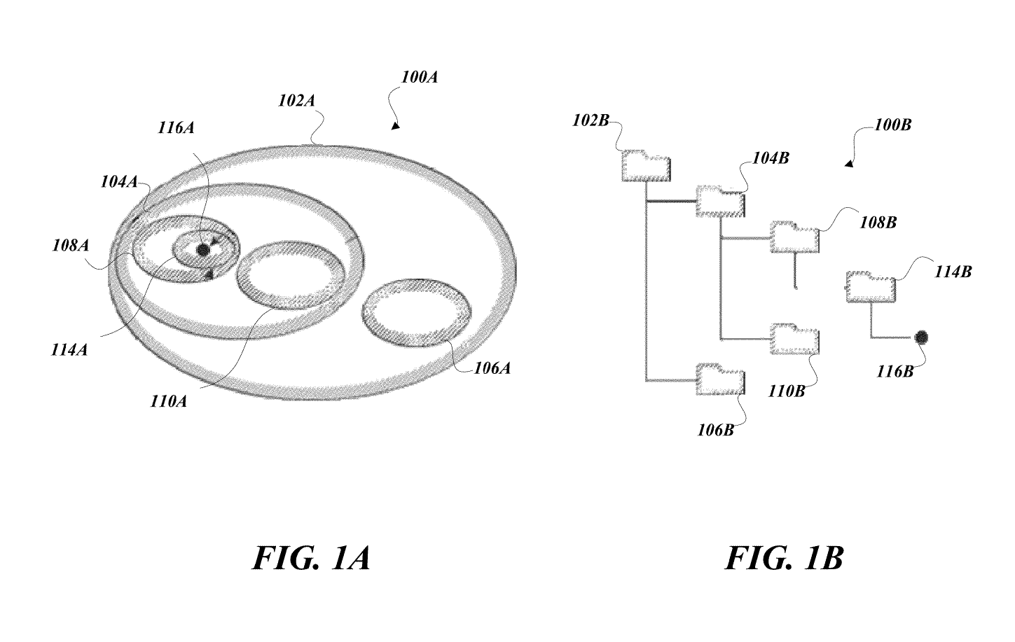

FIG. 1A illustrates a logical view 100a of object structures. An object structure 102A is illustrated to contain two other object structures 104A, 106A. The object structure 104A is illustrated to contain two other object structures 108A, 110A. The object structure 108A contains yet another object structure 114A. Within the object structure 114A is a user's intention 116A. FIG. 1B is a physical view 100b containing a module architecture that contains classes whose instantiations create the object structures 102A-114A. For example, a module 102B contains a class, the instantiation of which creates the object structure 102A. The module 102B also contains hierarchical modules 104B (whose instantiation creates the object structure 104A) and a module 106B (the instantiation of which creates the object structure 106A). The module 104B physically contains modules 108B (the instantiation of which creates the object structure 108A) and a module 110B containing a class (the instantiation of which creates the object structure 110A). The module 108B contains the module 114B which in turn contains a class (the instantiation of which creates the object structure 114A). The module 114B contains the physical user's intention 116B mirroring the user's intention 116A in the logical view 100A. As discussed, under this object-oriented paradigm, the user's intent 116A, 116B is resolved by extraction and identification of the context of interaction under a strict hierarchy of the modules 102B-114B (whereas various embodiments of the present subject matter are engineered to discover the user's intent without a strict hierarchy).

Static taxonomies are rarely successful. They're a single point of view on organization that doesn't map to a wide audience. They're fragile and break during growth. They're often obsolete on the day that a piece of software ships. A common mitigation strategy is to tack on an additional layer which eschews the taxonomy entirely offering a subset that the system deems relevant. This can succeed at getting users to commonly accessed elements quickly but does nothing to mediate the flaw in the general taxonomy itself. The problem is that there is a flaw. The taxonomy is never indexed on the context of the user as it pertains to time. There lacks a notion of now with a taxonomy, which focuses on what is a top. Various embodiments of the present subject matter to reduce or eliminate reliance on the top-down construction of the user interface and replace it with now-and architecture.

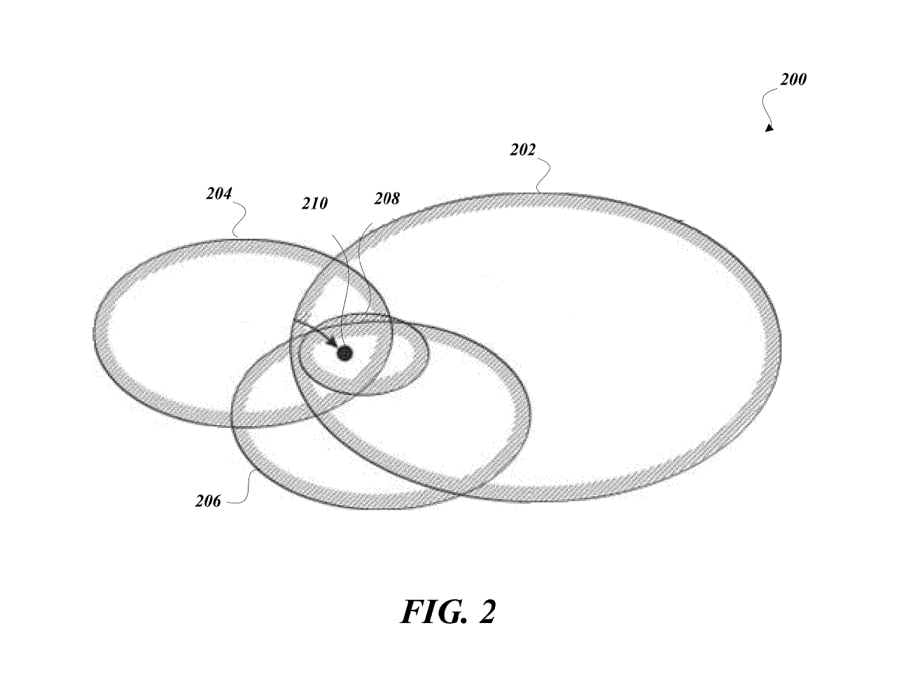

FIG. 2 is a pictorial diagram illustrating a logical view 200 of object structures. An object structure 202 has direct access to a user's intention 210. An object structure 204 also has direct access to the user's intention 210. Another object structure 206 also has direct access to the user's intention 210, and another object structure 208 also has access to the user's intention 210. Thus, each object structure 202-210 may access the user's intention 210 under a contextual community paradigm (CCP), as engineered by various embodiments of the present subject matter to define context between human and machine. This contextual community paradigm enables support of multiple taxonomies for any given object. Human and machine share context. The contextual community paradigm simplifies resolution of the user's intent, enabling automated interactions between human and machine spanning functions and applications; the paradigm extends context sharing between human and machine at the system level; the paradigm facilitates real-time context resolution; the paradigm presents natural interaction to suit each individual taxonomy while supporting multiple inheritances; the paradigm quantifies attributes for the user, such as the importance and relevance of the object, simplifying the view of complex systems; the paradigm permits human and machine to share a context, simplifying the process of intent resolution; the paradigm also enables extended unification and automation of tasks launched by the system. Furthermore, the paradigm is as much about managing comments such as events and information as it is about controlling web services and electronic devices.

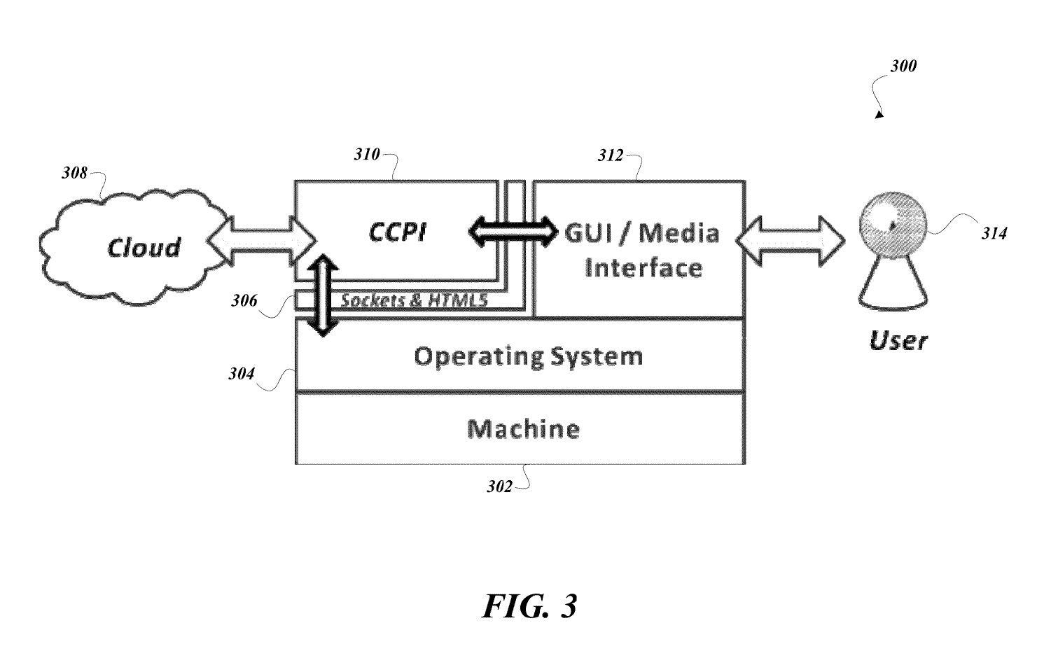

FIG. 3 is a block diagram illustrating a physical view 300 of the hardware architecture and software architecture implementing the contextual community paradigm. These architectures engineer software/hardware structures and analyzing concepts as members of communities, with the paradigm determining multiple, probable intents from context. A machine 302 contains one or more processors that execute computing instructions. An operating system 304 executes on the machine 302. The operating system 304 communicates with a software layer called a contextual community paradigm interface 310 through a layer of sockets and HTML5 306. The contextual community paradigm interface 310 also communicates through a graphical user interface and/or media interface 312 via the same sockets and HTML5 306. The contextual community paradigm interface 310 may telecommunicate with a cloud 308. A user 314 interacts with the contextual community paradigm interface 310 via the graphical user interface and/or media interface 312. Under the contextual community paradigm, users, singly or jointly, can interact with objects through contextual communities in the same way as a social network. Furthermore, interaction methods are unified so that the treatment of an object can be indistinguishable from the human member of a social network. Under this paradigm, objects such as products and services (i.e., home appliances, motor vehicles, and restaurants) are members of the contextual community. They are treated as facets of automated communication and business transactions with the products and service providers.

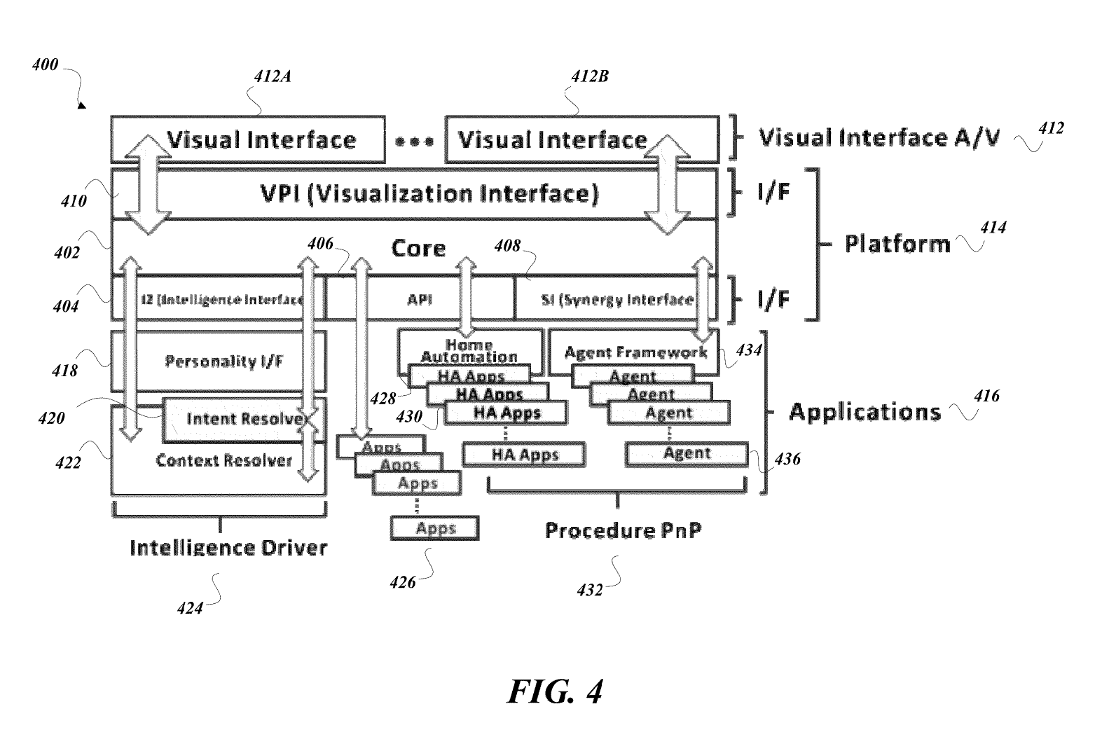

FIG. 4 is a block diagram illustrating a physical view 400 of the contextual community paradigm interface in more detail. The physical view 400 is segregated into various layers. A visual interface A/V (audio/video) layer 412 presents visual interfaces such as visual interfaces 412A, 412B. A platform layer 414 contains three additional layers: an interface layer 410 pertaining to VPI (visualization interface); and a core layer 402 which communicates with the visual interfaces 412A, 412B. Other interface layers include an interface layer 404 containing an intelligence interface (I2); application programming interface (API) 406; and synergy interface (SI) 408.

The applications layer 416 contains numerous pieces of software. For example, a personality interface layer 418 operates subjacent to the intelligence interface (I2) 404. An intent resolver 420 layer operates subjacent to the personality interface layer 418. The intent resolver 420 communicates with the core 402 to assist in resolving users' intents. The intent resolver 420 also communicates with the core 402 and a context resolver 422 to facilitate resolving context and ultimately users' intents. The context resolver 422 also communicates with the core 402. Collectively, the personality interface layer 418, the intent resolver layer 420, and the context resolver 422 are intelligence drivers 424 of the contextual community paradigm interface 400 interfacing through the intelligence interface (I2) 404. One or more pieces of apps 426 communicate with the core 402. Apps that are procedure plug-and-play (PnP) 432 communicate with the core 402 to accomplish their operations. For example, a home automation framework 428 facilitates one or more pieces of home automation apps 430 to operate their computing instructions using the core 408. As another example, an agent framework 434 facilitates one or more agents 436 to operate with the core 408.

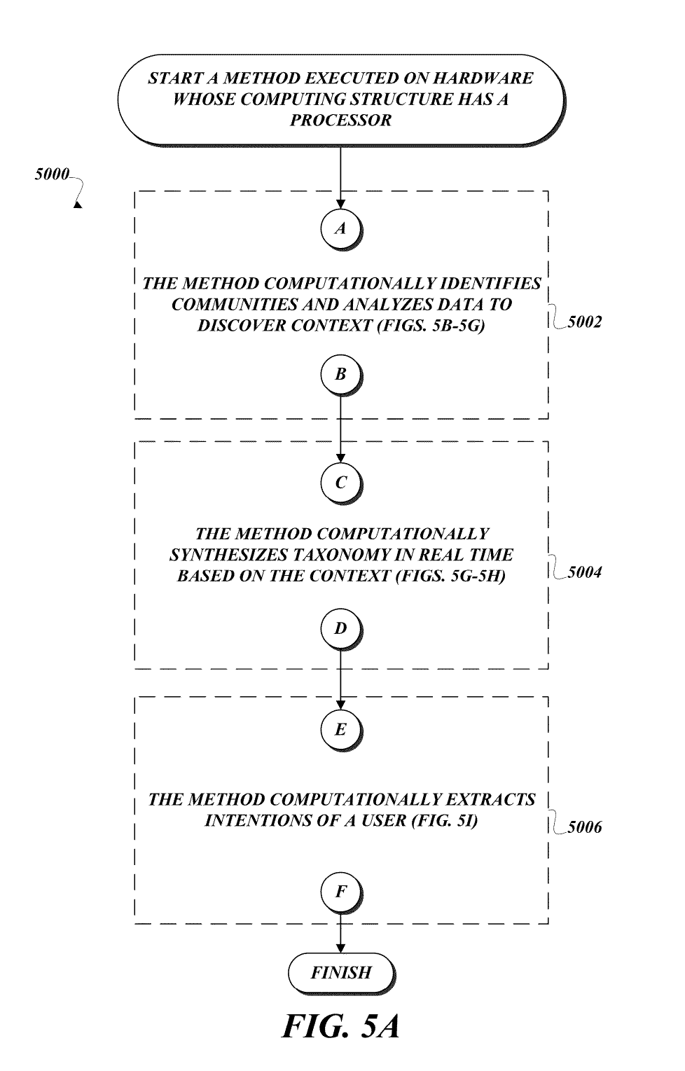

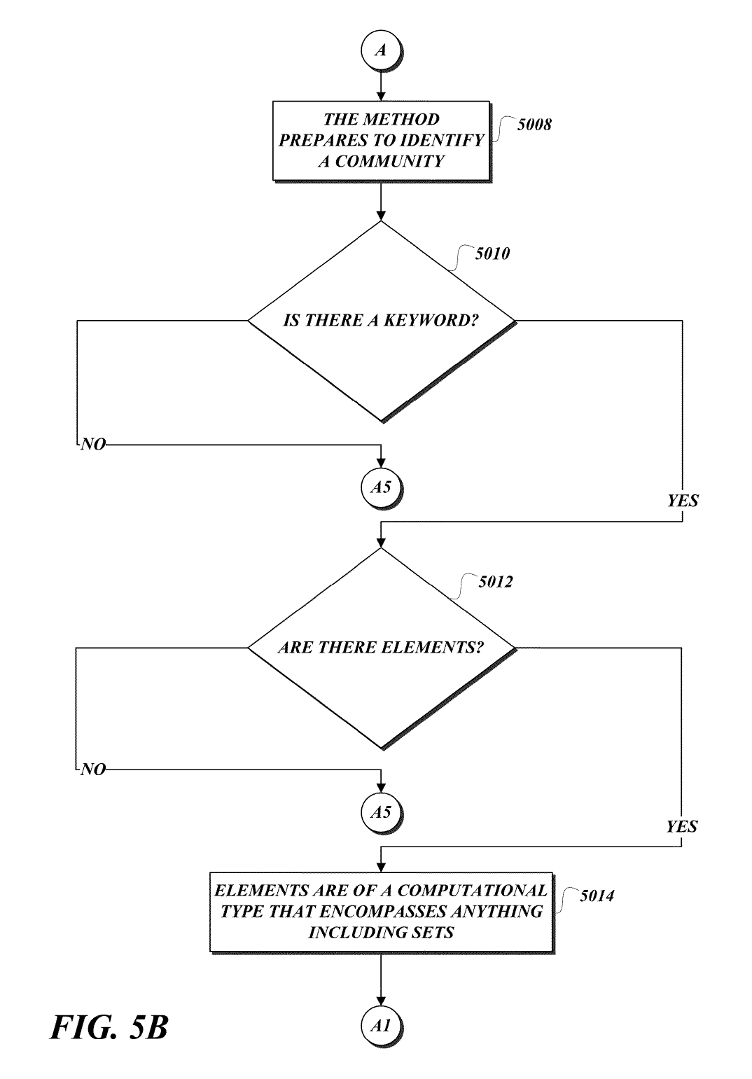

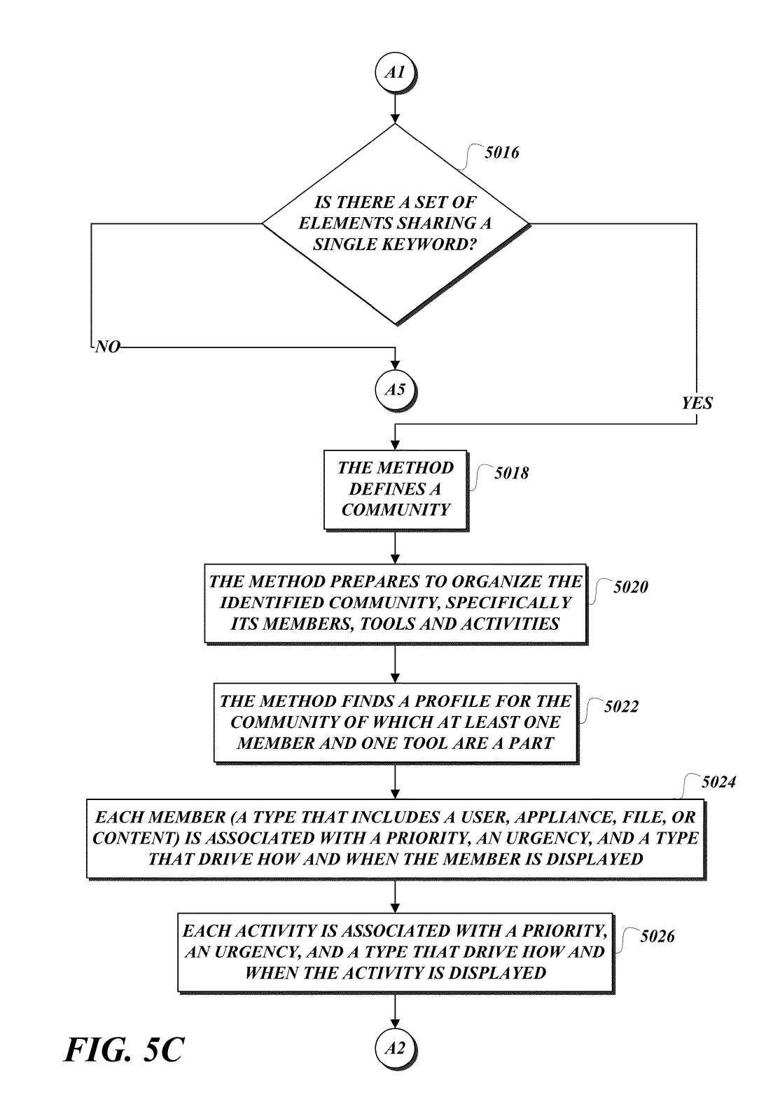

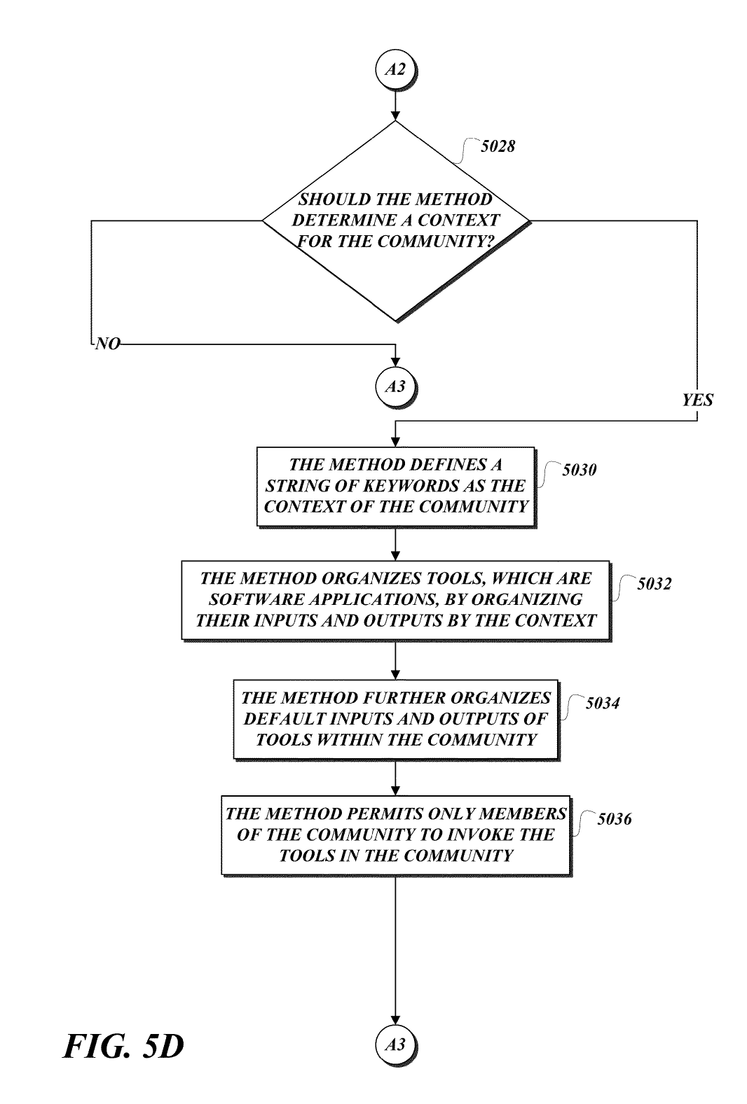

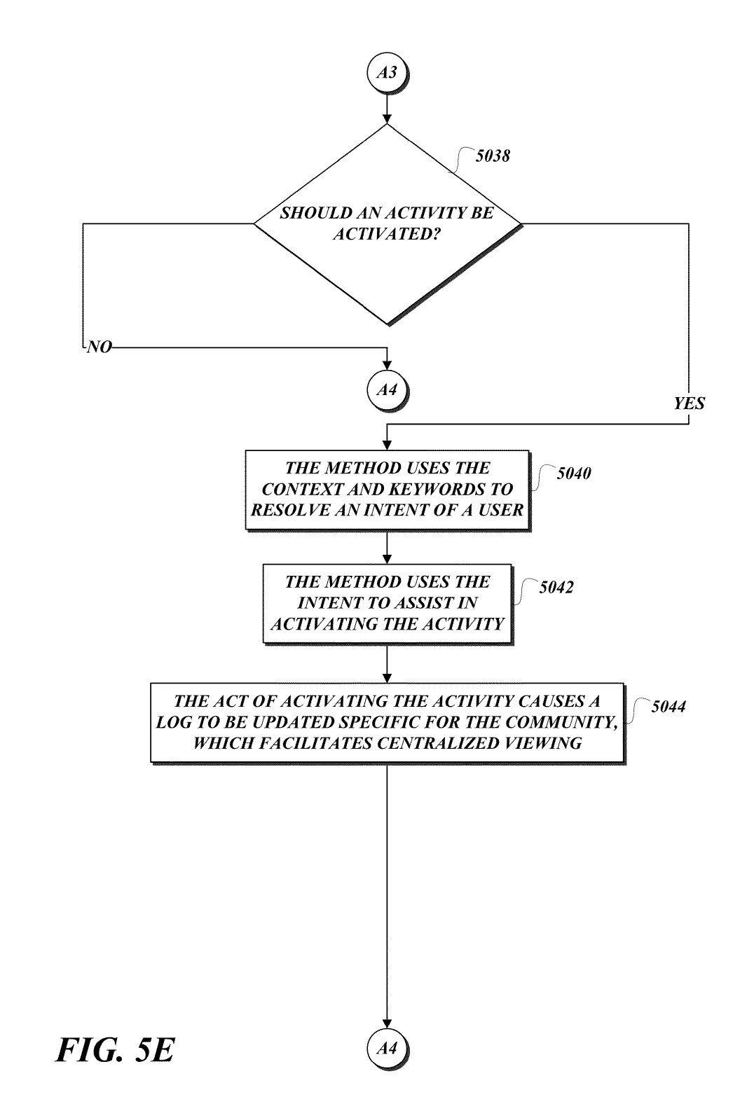

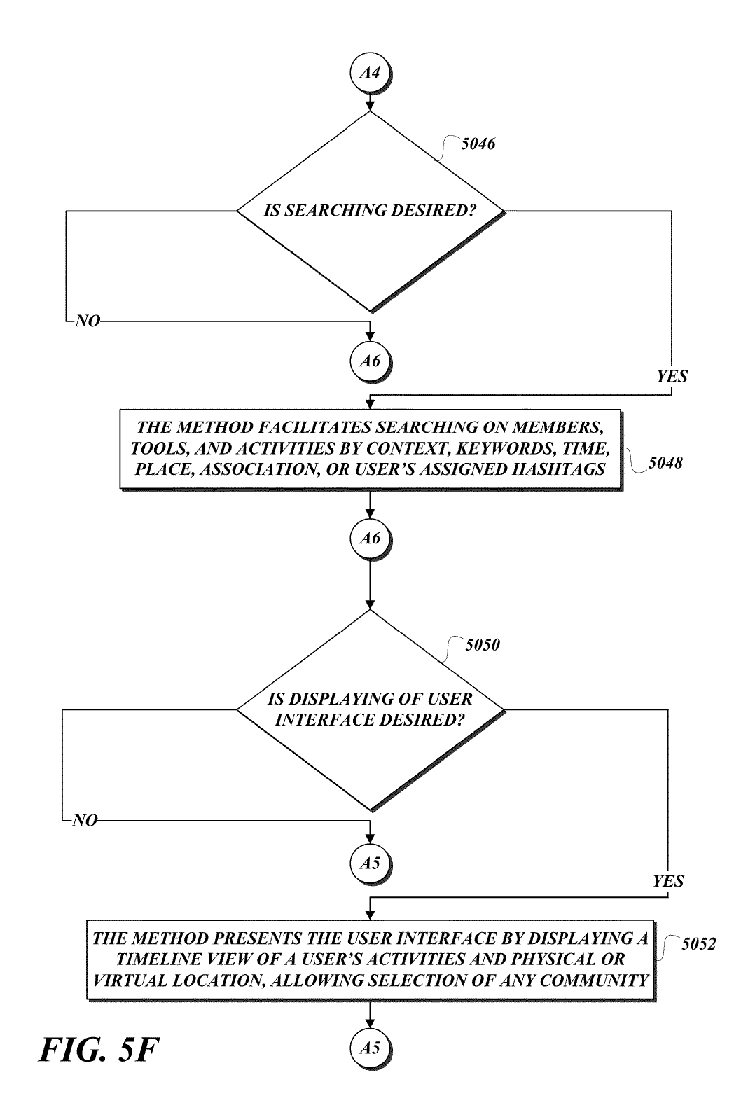

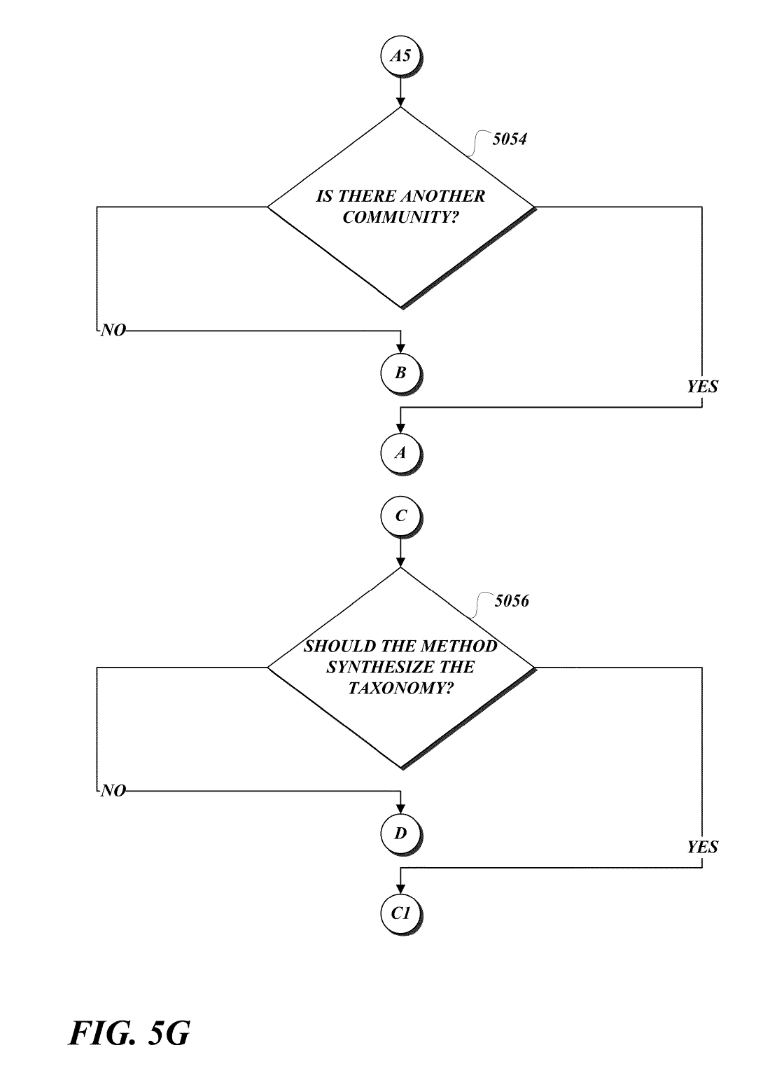

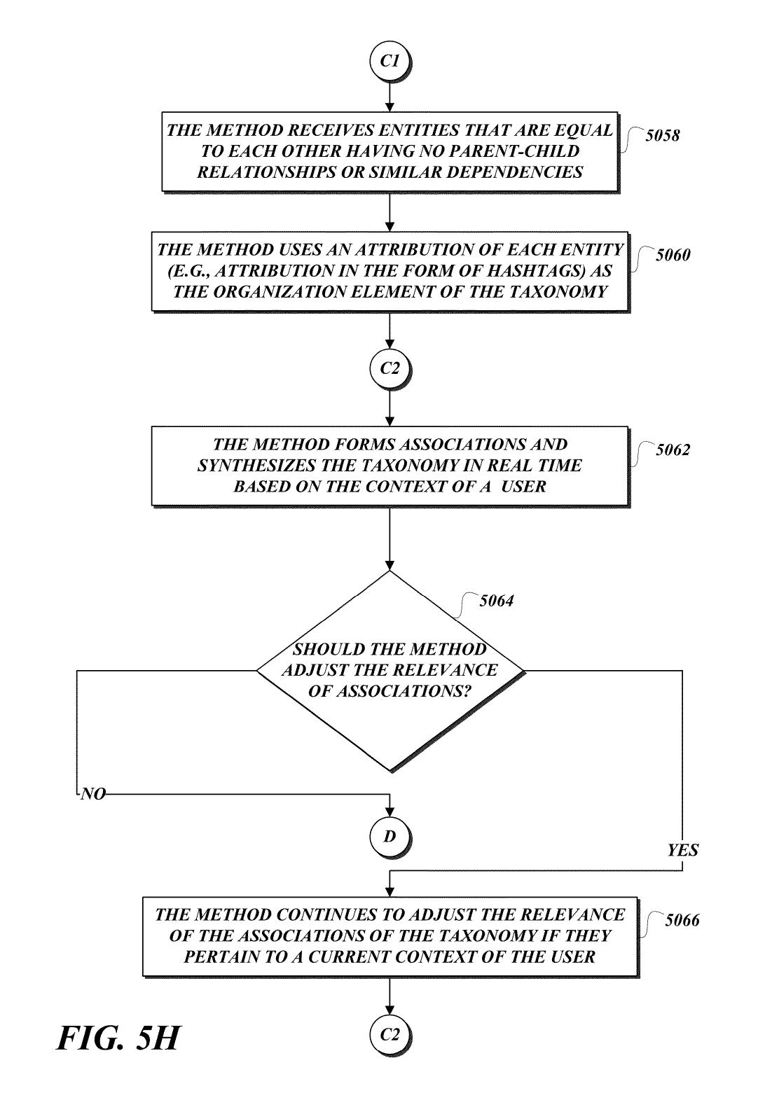

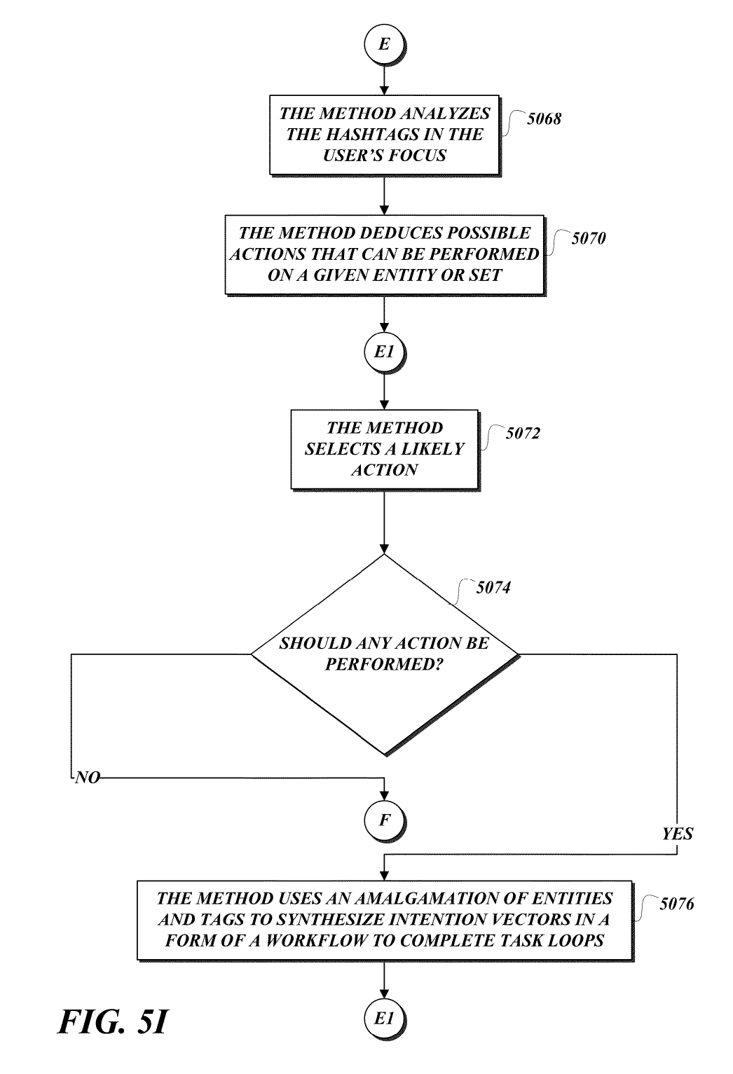

FIGS. 5A-5I are process diagrams implementing an exemplary method 5000. The method 5000 can be used on most computing devices including smart phones, tablets, computers, and set-top boxes. From a start block, the method 5000 proceeds to a set of method steps defined between a continuation terminal (“terminal A”) and another continuation terminal (“terminal B”). The set of method steps 5002 computationally identifies communities and analyzes data to discover context. From terminal A (FIG. 5B), the method proceeds to block 5008 where the method prepares to identify a community. At decision block 5010, a test is performed to determine whether there is a keyword. If the answer to the test at decision block 5010 is No, the method proceeds to another continuation terminal, terminal B. If instead, the answer to the test at decision block 5010 is Yes, the method proceeds to decision block 5012 where another test is performed to determine whether there are elements. If the answer to the test at decision block 5012 is No, the method proceeds to terminal B. Otherwise, if the answer to the test at decision block 5012 is Yes, the method proceeds to block 5014 where elements are of a computational type that encompass anything including sets. The method then continues to another continuation terminal (“terminal A1”).

From terminal A1 (FIG. 5C), the method proceeds to decision block 5016 where a test is performed to determine whether there is a set of elements sharing a single keyword. If the answer to the test at decision block 5016 is No, the method proceeds to another continuation terminal (“terminal A5”). Otherwise, if the answer to the test at decision block 5016 is Yes, the method proceeds to block 5018 where the method defines a community. Communities may or may not be interrelated. Communities are federated, loosely coupled, and non-hierarchical thematic sets. Some may be unrelated, while other communities may have multiple levels of sub-communities that inherit attributes. The method then proceeds to block 5020 where the method prepares to organize the identified community, specifically its members, tools, and activities. At block 5022, the method finds a profile for the community of which at least one member and one tool are a part. At block 5024, each member (a type that includes a user, appliance, file, or contact) is associated with a priority, urgency, and a type that drives how and when the member is displayed. At block 5026, each activity is associated with a priority, an urgency, and a type that drives how and when the activity is displayed. The method then continues to another continuation terminal (“terminal A2”).

From terminal A2 (FIG. 5D), the method 5000 proceeds to decision block 5028 where a test is performed to determine whether the method determines a context for the community. If the answer to the test at decision block 5028 is No, the method proceeds to another continuation terminal (“terminal A3”). Otherwise, if the answer to the test at decision block 5028 is Yes, the method proceeds to block 5030 where the method defines a string of keywords as the context of the community. At block 5032, the method organizes tools, which are software applications, by organizing their inputs and outputs by the context. At block 5034, the method further organizes default inputs and outputs of tools within the community. At block 5036, the method permits only members of the community to invoke the tools in the community. The method then continues to another continuation terminal, terminal A3.

From terminal A3 (FIG. 5E), the method proceeds to decision block 5038 where a test is performed to determine whether an activity should be activated. If the answer is No to the test at decision block 5038, the method proceeds to another continuation terminal (“terminal A4”). Otherwise, the answer to the test at decision block 5038 is Yes, and the method proceeds to block 5040 where the method uses the context and keywords to resolve an intent of a user. At block 5042, the method uses the intent to assist in activating the activity. As an example, users may command the system to execute a complex series of activities with a minimum of interaction. For instance, a user may request that a bedroom temperature be set to 68 degrees Fahrenheit when a movie he is watching finishes. The system uses a context of the “home” community to know when the television's member's movie member finishes, calculate how long it will take to change room temperature, and activate the HVAC at the right time and at the right temperature. At block 5044, the act of activating the activity causes a log to be updated specifically for the community, which facilitates centralized viewing. The method then continues to terminal A4.

From terminal A4 (FIG. 5F), the method proceeds to decision block 5046 where a test is performed to determine whether searching is desired. If the answer to the test at decision block 5046 is No, the method proceeds to another continuation terminal (“terminal A6”). Otherwise, if the answer to the test at decision block 5046 is Yes, the method proceeds to block 5048 where the method facilitates searching on members, tools, and activities by contacts, keywords, time, place, association or a user's assigned hashtags. The method then continues to terminal A6 and further proceeds to yet another decision block 5050 where a test is performed to determine whether displaying the user interface is desired. If the answer to the test at decision block 5050 is No, the method proceeds to another continuation terminal (“terminal A5”). Otherwise, if the answer to the test at decision block 5050 is Yes, the method proceeds to block 5052 where the method presents the user interface by displaying a timeline view of a user's activities and physical and virtual location, allowing selection of any community. The method then continues to terminal A5.

From terminal AS (FIG. 5G), the method proceeds to decision block 5054 where a test is performed to determine whether there is another community. If the answer to the test at decision block 5054 is No, the method proceeds to terminal B. Otherwise, if the answer to the test at decision block 5054 is Yes, the method proceeds to terminal A and skips back to block 5008 where the above-identified processing steps are repeated.

From terminal B (FIG. 5A), the method proceeds to a set of method steps 5004 defined between a continuation terminal (“terminal C”) and another continuation terminal (“terminal D”). The set of method steps 5004 computationally synthesizes the taxonomy in real time based on the context. From terminal C (FIG. 5G), the method proceeds to decision block 5056 where a test is performed to determine whether the method should synthesize the taxonomy. Digressing, as an example, users can input tags to explicitly create associations (#family). The paradigm will also create tags to increase the granularity of the relevance (#local). The context of the user plays a role as (#local) is dependent on their location at the time they are using the software (#seattle). The paradigm can then, in real time, synthesize even more relevant subsets (#nearby). Returning, if the answer to the test at decision block 5056 is No, the method proceeds to terminal D. Otherwise, if the answer to the test at decision block 5056 is Yes, the method proceeds to another continuation terminal (“terminal C1”).

From terminal C1 (FIG. 5H), the method proceeds to block 5058 where the method receives entities that are equal to each other and have no parent-child relationships or similar dependencies. At block 5060, the method uses an attribution of each entity (e.g., attribution in the form of hashtags) as the organization element of the taxonomy. The method then continues to another continuation terminal (“terminal C2”). At block 5062, the method forms associations and synthesizes the taxonomy in real time based on the context of a user. At decision block 5064, a test is performed to determine whether the method adjusts the relevance of associations. If the answer to the test at decision block 5064 is No, the method continues to terminal D. Otherwise, if the answer to the test at decision block 5064 is Yes, the method proceeds to block 5066 where the method continues to adjust the relevance of the associations of the taxonomy if they pertain to a current context of the user. The method then continues to terminal C2 and skips back to block 5062 where the above-identified processing steps are repeated.

From terminal D (FIG. 5A), the method proceeds to a set of method steps 5006 defined between a continuation terminal (“terminal E”) and another continuation terminal (“terminal F”). The set of method sets 5006 computationally extracts an intention or probable intentions of a user. From terminal E (FIG. 5I), the method proceeds to block 5068 where the method analyzes the hashtags in the user's focus. At block 5070, the method deduces possible actions that can be performed on a given entity or set. The method then continues to another continuation terminal (“terminal E1”). At block 5072, the method selects a likely action. The method then continues to decision block 5074 where a test is performed to determine whether any action should be performed. If the answer to the test at decision block 5074 is No, the method continues to terminal F and terminates execution. Otherwise, if the answer to the test at decision block 5074 is Yes, the method proceeds to block 5076 where the method uses an amalgamation of entities and tags to synthesize intention vectors in the form of a workflow to complete task loops. Digressing, similar to search vectors, the paradigm can synthesize intention vectors. So given an amalgamation of entities and hashtags a simplified workflow can be presented to complete task loops. For example, (#family+#local+#restaurant) would present a (#booking) workflow that would automatically derive (#available) times for all entities (including the restaurant). In several embodiments, besides hashtags, the method uses a broad array of symbolic conventions, each with specific meanings. In a few embodiment, such a technique is used to not only synthesize intention but also to define context. Returning, the method then continues to terminal E1 and skips back to block 5072 where the above-identified processing steps are repeated.

The contextual community paradigm includes numerous technical features: interface layer 410 pertaining to a VPI Layer including bi-directional interaction; ordering chaos using priority, urgency, interest, relevance, coordinates, profile, and type;

keywords and context to determine intent, and execute on that intent; interoperability among members of the communities; smart services including on demand search, sales, and marketing; and multiplicity of taxonomies supported by utilizing a social network services (SNS) engine.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system comprising:
a machine containing one or more processors, the specific hardware structure of which is suitable for executing pieces of software including:
an operating system;
a graphical user interface and a media interface;
a layer of sockets and HTML5; and
a contextual community paradigm interface which is capable of supporting multiple taxonomies for an object, the object being a member of a contextual community, and the object with which a user interacts through the contextual community as if it were a social network.

2. The system of claim 1, further comprising an intent resolver having a capacity to resolve an intent of the user.

3. The system of claim 1, further comprising a context resolver which is suitable for resolving a context of the user.

4. A method comprising:
identifying a community and analyzing data to resolve a context;
synthesizing taxonomy in real time based on the context; and
extracting intention of a user.

5. The method of claim 4, wherein identifying the community includes determining whether there is a keyword from which a community is formed.

6. The method of claim 5, wherein identifying the community includes determining whether there are elements.

7. The method of claim 6, wherein identifying the community includes determining whether the elements are sharing the keyword.

8. The method of claim 7, wherein identifying the community includes defining the community if there are elements sharing the keyword.

9. The method of claim 8, wherein identifying the community includes organizing members of the community, each member being associated with a priority, urgency, and a computational type that drives how and when the member is displayed.

10. The method of claim 9, wherein identifying the community includes organizing activities of the community, each activity being associated with a priority, urgency, and a computational type that drives how and when the activity is displayed.

11. The method of claim 10, wherein identifying the community includes defining a string of keywords as the context of the community.

12. The method of claim 11, wherein identifying the community includes resolving an intent of a user by using the context and keywords.

13. The method of claim 12, further comprising activating an activity of requesting that a room temperature be set to a level after another activity terminates, using the context of the community to know when the another activity terminates, calculating how long to change room temperature, and activating machinery at a set time and at a set temperature level.

14. The method of claim 11, further comprising searching members, tools, or activities by contacts, keywords, time, place, association, or the user's assigned hashtags.

15. The method of claim 4, wherein synthesizing taxonomy in real time based on the context includes receiving hashtags to create associations, creating hashtags to increase granularity of relevance, using the context of the user based on the location at the time the user is using the method, and synthesizing subset taxonomies.

16. The method of claim 4, wherein synthesizing taxonomy in real time based on the context includes receiving entities that are equal to each other and have no parent-child relationships, using an attribution of each entity in the form of hashtags as the organizing element of the taxonomy, and forming associations and synthesizing the taxonomy in real time based on the context of the user.

17. The method of claim 16, further comprising adjusting the relevance of the associations of the taxonomy in accordance with a current context of the user.

18. The method of claim 4, wherein extracting an intention of a user includes analyzing hashtags in the focus of the user, deducing possible actions that can be performed on an entity, selecting a likely action, and synthesizing intention vectors in the form of a workflow to complete the action.

19. The method of claim 18, wherein extracting an intention of a user includes using entities and hashtags to synthesize the intention vectors.

20. A computer-readable medium, which is non-transitory, having computer-executable instructions stored thereon for implementing a method, comprising:
identifying a community and analyzing data to resolve a context;
synthesizing taxonomy in real time based on the context; and
extracting an intention of a user.
